(19) United States
(12) Patent Application Publication
(10) Pub. No.: US 2019/0023331 A1
(43) Pub. Date: Jan. 24, 2019

(54) TRUCK BED EXTENSION APPARATUS

(71) Applicant: Quick Extend-A-Bed, LLC, Newport Beach, CA (US)

(72) Inventor: Larry A. Quick, Anaheim, CA (US)

(21) Appl. No.: 16/112,452

(22) Filed: Aug. 24, 2018

Related U.S. Application Data
(63) Continuation-in-part of application No. 15/961,024, filed on Apr. 24, 2018.
Application No. 15/961,024 is a continuation of application No. PCT/US2016/057510, filed on Oct. 18, 2016.
Application No. PCT/US2016/057510 is a continuation of application No. 15/277,273, filed on Sep. 27, 2016, now Pat. No. 9,834,260.
Application No. 15/277,273 is a continuation-in-part of application No. 14/956,692, filed on Dec. 2, 2015, now Pat. No. 9,452,793.
(60) Provisional application No. 62/246,740, filed on Oct. 27, 2015.
(60) Provisional application No. 62/550,129, filed on Aug. 25, 2017.

(51) Int. Cl. B62D 33/03; B62D 33/027

(52) U.S. Cl. CPC B62D 33/03; B62D 33/0273

(57) ABSTRACT

A truck bed extension apparatus having a deployed configuration that improves visibility of the taillights of the pickup truck. The truck bed extension apparatus can include faceted shapes allowing full visibility from a wider range of angles and/or can include improved features for allowing visibility of taillights through walls of a bed extender.

### REFERENCE TO RELATED APPLICATIONS

This application claims the benefit of provisional application U.S. 62/550,129, filed Aug. 25, 2017, which is incorporated herein by reference.

### BACKGROUND OF THE INVENTIONS

The present inventions relate generally to truck tailgate accessories and, more particularly, to truck bed extension apparatuses for selectively increasing the length of a truck bed and enclosing the lengthened truck bed area.

### SUMMARY OF THE INVENTIONS

A truck bed extension apparatus according to some embodiments, for use in extending a usable area of a truck having a pickup box and truck bed that defines an open end and that includes a primary tailgate pivotally movable between a closed configuration covering the open end and an open configuration not covering the open end. The extension apparatus can have a hinge assembly that includes a hinge plate coupled to the primary tailgate, the hinge plate having a front edge adjacent a free edge of the primary tailgate. An auxiliary tailgate includes a lower edge pivotally coupled to the front edge of the hinge plate, the auxiliary tailgate being pivotally movable between a stowed configuration generally co-planar with and adjacent to the hinge plate and a deployed configuration extending upwardly from and perpendicular to the hinge plate.

A pair of side panels are pivotally coupled to side edges of the auxiliary tailgate, respectively, each side panel being selectively movable between a retracted configuration generally co-planar with and bearing against an inside surface of the auxiliary tailgate and an extended configuration generally perpendicular to the inside surface of the auxiliary tailgate. The truck bed is extended and enclosed when the primary tailgate is at the open configuration, the auxiliary tailgate is at the deployed configuration, and the pair of side panels is at the extended configuration.

Thus, some embodiments disclosed herein can provide a truck bed extension apparatus for selectively increasing the length of a pickup truck bed.

Additionally, some embodiments disclosed herein can provide a truck bed extension apparatus, as aforesaid, having an auxiliary tailgate that may be stowed away on an inner surface of the truck's primary tailgate or deployed upwardly when the primary tailgate is opened.

Further, some embodiments disclosed herein can provide a truck bed extension apparatus, as aforesaid, in which the lengthened truck bed may be enclosed by the auxiliary tailgate and foldout side panels.

Another aspect of at least one of the inventions disclosed herein includes the realization that an auxiliary tailgate that folds against the primary tailgate about a hinge can suffer from fitment problems caused by sagging of the assembly when folded. For example, when such an auxiliary tailgate is folded into the stowed position and the primary tailgate of the associated vehicle is closed (i.e., oriented generally vertically), the weight of the auxiliary tailgate pulls downwardly on the hinge assembly and can thus sag downwardly. If the auxiliary tailgate sags to a position that is excessively low along the inner surface of the primary tailgate, the auxiliary tailgate can be pinched as a user attempts to close the primary tailgate, i.e., pinched between the end of the primary tailgate and the truck bed. Thus, an auxiliary tailgate assembly that sags should be mounted higher on the primary tailgate and/or should be sized to a shorter dimension such that it does not become pinched between the primary tailgate and the truck bed. Such sizing and/or positioning, however, limits the overall height of the auxiliary tailgate when in a deployed position, and thus can create undesirable effects on aerodynamics and cargo capacity.

Thus, in accordance with at least some of the embodiments disclosed herein, a truck bed extension assembly can include an auxiliary tailgate member having a base edge pivotally attached to a top edge of a primary tailgate with a hinge. The hinge can include physical stops limiting movement of the hinge, in the closing direction, to the pre-determined angle, for example, approximately 90 degrees. As such, when the auxiliary tailgate is folded against the primary tailgate, the physical stops on the hinge can prevent sagging of the auxiliary tailgate.

Another aspect of at least one of the inventions disclosed herein includes the realization that visibility of taillights of a pickup truck incorporating a bed extender, for example, bed extenders that extend onto an open tailgate of a pickup truck, can accommodate improved visibility of the taillights of the pickup truck. For example, a bed extender can include faceted shapes allowing full visibility from a wider range of angles and/or can include improved features for allowing visibility of taillights through walls of a bed extender.

For example, in some embodiments, a bed extender can be configured to define a generally box shaped wall on top of an open tailgate of a pickup truck. The generally box shaped walls can include beveled corners or a faceted shape that allow the taillights of the pickup truck to be viewed at a wider range of angles.

Further, in some embodiments, a generally boxed shape bed extender which includes a plurality of walls extending upwardly from an open tailgate of a pickup truck, can include louvered apertures through which the taillights of a pickup truck can be viewed from a range of angles. Further, in some embodiments, a bed extender for a pickup truck including a plurality of walls extending upwardly from an open tailgate of a pickup truck, can include prisms for receiving light from a taillight and redirecting the light through an interior of the bed extender and outwardly through a rear wall of the bed extender.

In yet other embodiments, a bed extender for a pickup truck can include integrated auxiliary taillights on rear facing walls of the bed extender. In some embodiments of such a bed extender, the auxiliary lights can be mounted flush with outer surfaces of the bed extender walls and the wiring for such lights can be embedded within the walls so as to provide enhanced protection for such lights and wiring.

Further, some embodiments of a bed extender can include an auxiliary backup camera mounted in a rear-facing wall of a bed extender for a pickup truck. In some embodiments, the backup camera can be mounted with an outer surface of the bed extender wall so to avoid damage when the bed extender is folded.

Other objects and advantages of the inventions disclosed herein are apparent from the following description taken in connection with the accompanying drawings, wherein is set forth by way of illustration and example, embodiments of this invention.

### BRIEF DESCRIPTION OF THE DRAWINGS

FIG. 1 is a perspective view of a truck bed extension apparatus according to a preferred embodiment of the present invention illustrating the apparatus in an extended and enclosed configuration;

FIG. 2 is another perspective view of the extension apparatus as in FIG. 1, illustrating the apparatus in an extended but not enclosed configuration;

FIG. 3 is another perspective view of the extension apparatus as in FIG. 1, illustrating the auxiliary tailgate in a released configuration;

FIG. 4 is another perspective view of the extension apparatus as in FIG. 1, illustrating the auxiliary tailgate in a stowed configuration;

FIG. 5 is another perspective view of the extension apparatus as in FIG. 1, illustrating the primary tailgate in a closed configuration;

FIG. 6 is a perspective view from reverse angle of the extension apparatus as in FIG. 5;

FIG. 7a is an isolated view on an enlarged scale taken from FIG. 1;

FIG. 7b is an isolated view on an enlarged scale taken from FIG. 2;

FIG. 7c is an isolated view on an enlarged scale taken from FIG. 3;

FIG. 8a is an isolated view on an enlarged scale taken from FIG. 4;

FIG. 8b is an isolated view on an enlarged scale taken from FIG. 6;

FIG. 9 is an isolated perspective view of one side panel taken from FIG. 1;

FIG. 10 is an isolated perspective view of another side panel taken from FIG. 1;

FIG. 11 is an isolated perspective view of the auxiliary tailgate taken from FIG. 1;

FIG. 12a is an isolated view of a first hinge;

FIG. 12b is an isolated view of a second hinge;

FIG. 13a is an isolated view on an enlarged scale taken from FIG. 1;

FIG. 13b is an isolated view on an enlarged scale taken from FIG. 1; and

FIG. 14 is an isolated view on an enlarged scale taken from FIG. 3.

FIG. 15 is a schematic side elevational view of a the extension apparatus of FIG. 1, illustrating a sagging effect of the extension apparatus.

FIG. 16 is an exploded view of a modification of a portion of the extension apparatus of FIG. 1.

FIG. 17 is an enlarged schematic, side elevational view of the hinge of FIG. 16.

FIG. 18 is a perspective schematic view of yet another modification of a portion of the extension apparatus of FIG. 1.

FIG. 19 is a schematic side elevational view of the hinge of FIG. 16 and showing three different positions of the extension apparatus.

FIG. 20 is a perspective view of another embodiment of a bed extender for a pickup truck.

FIG. 21 is a perspective view of the bed extender of FIG. 20 in a folded state.

FIG. 22 is a top plan view of the bed extender of FIG. 20.

FIG. 23 is a perspective view of yet another embodiment of the bed extender including optional louvered apertures.

FIG. 24 is a partial schematic cross-sectional view of the bed extender of FIG. 23, taken along line 24.-24.

### DETAILED DESCRIPTION OF THE PREFERRED EMBODIMENT

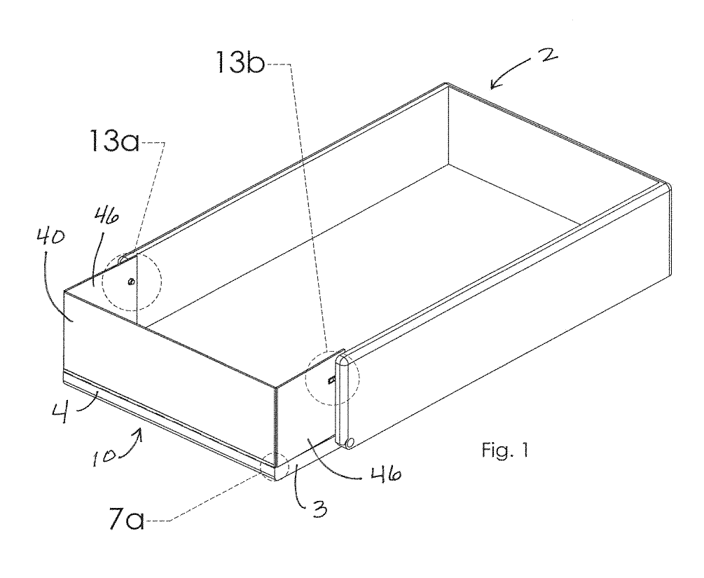

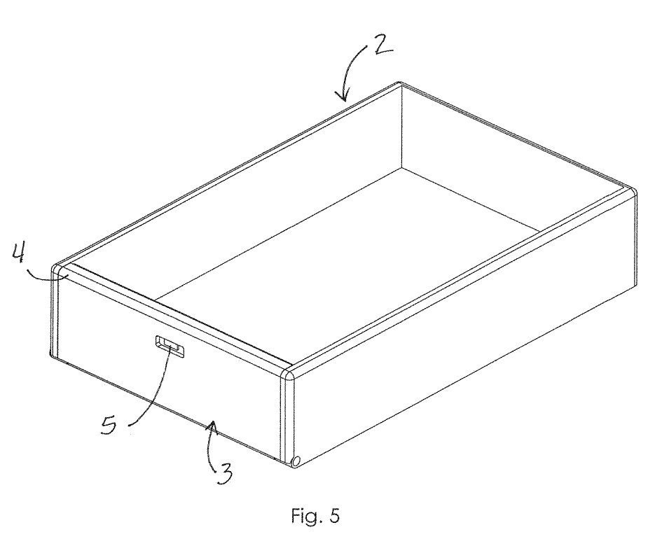

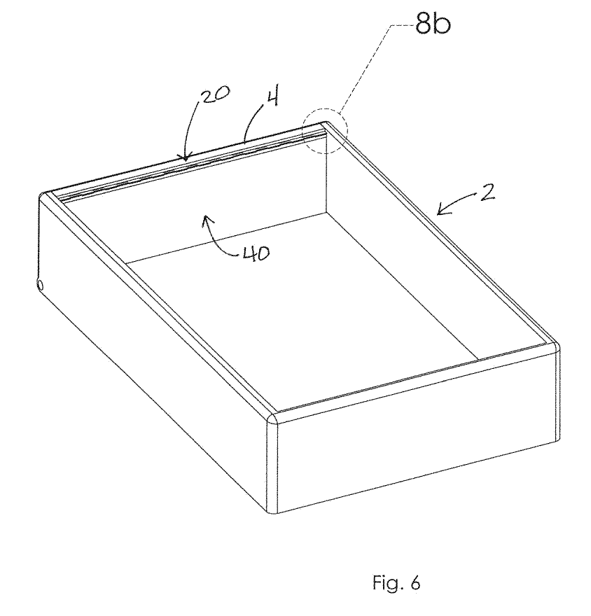

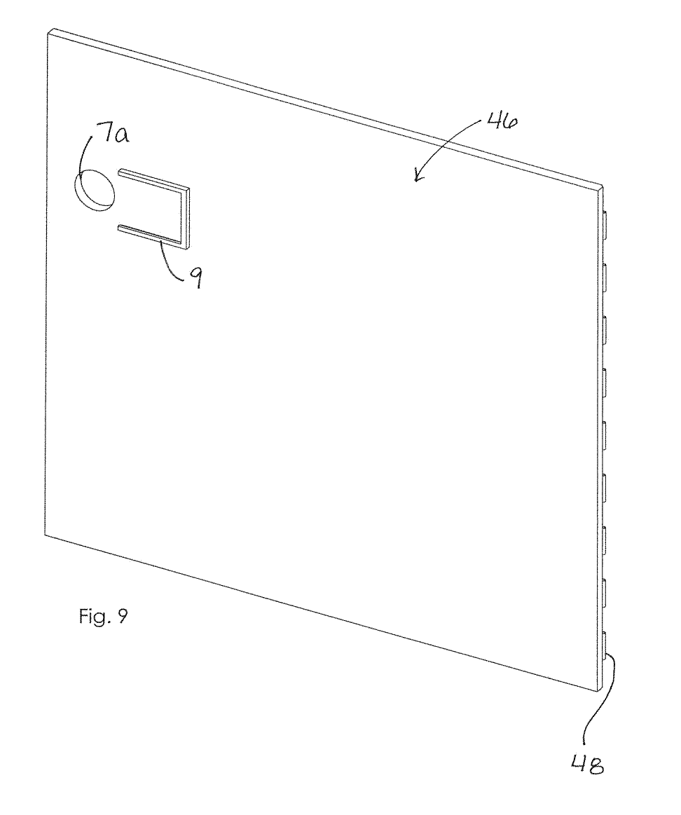

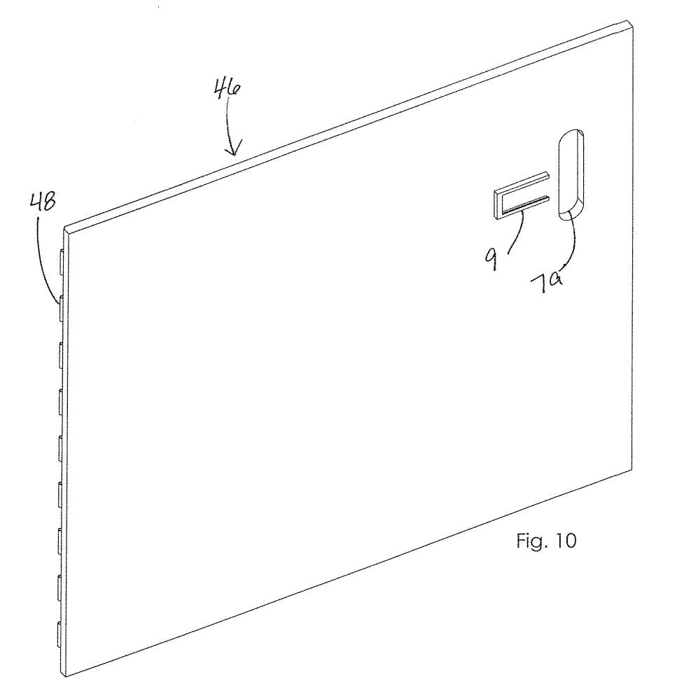

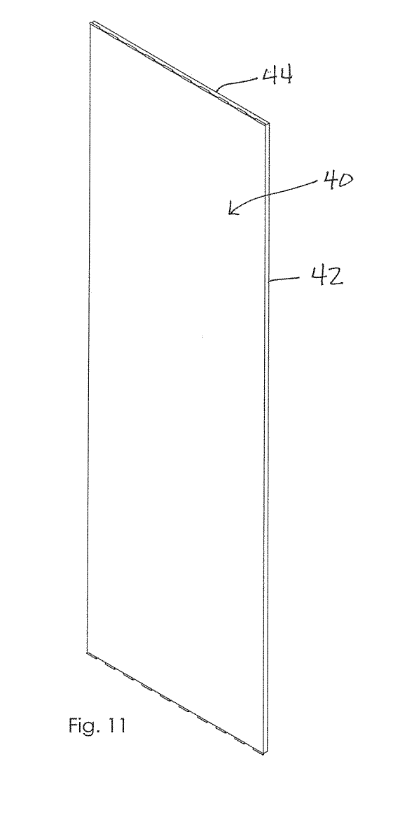

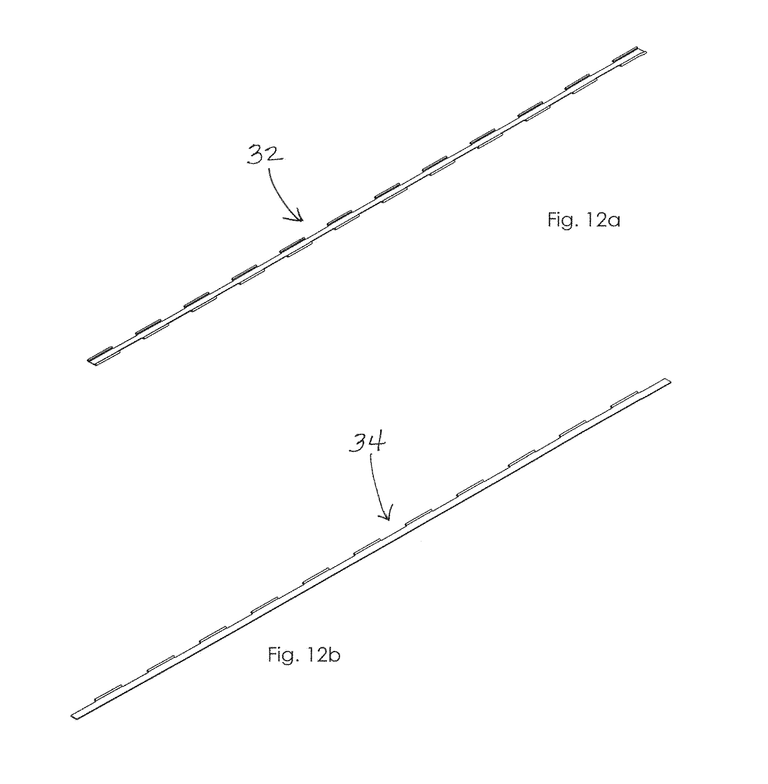

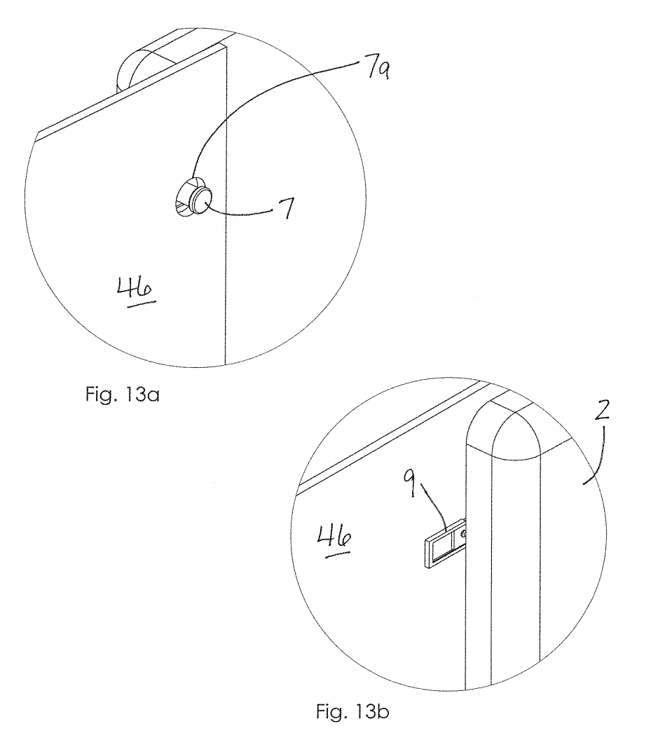

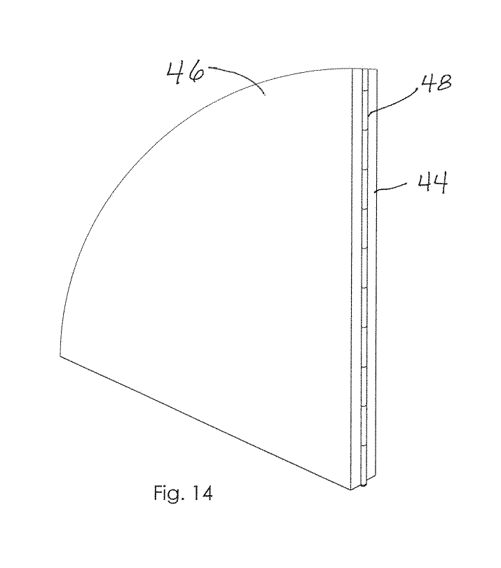

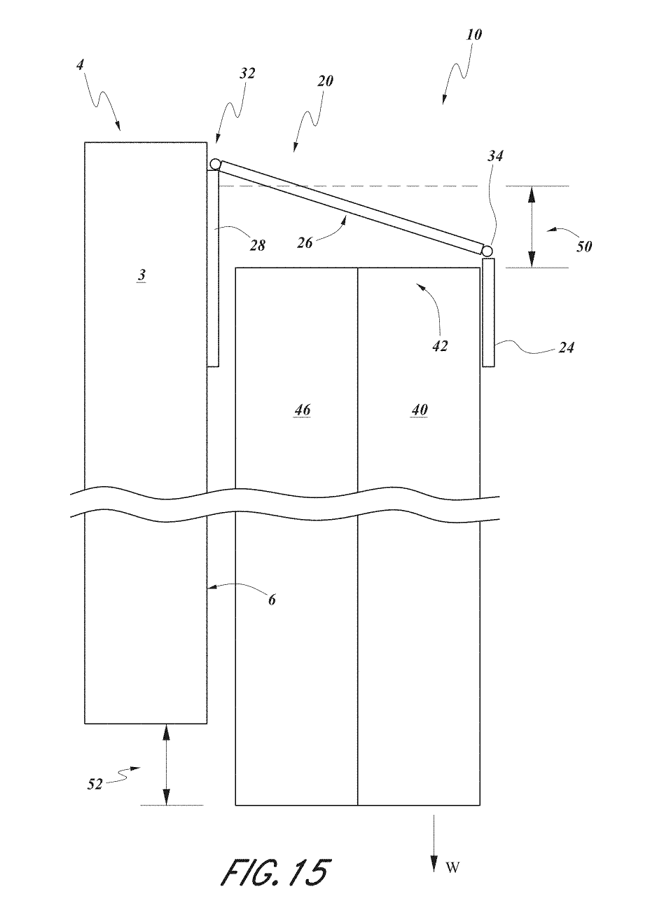

A truck bed extension apparatus according to a preferred embodiment will now be described in detail with reference to FIGS. 1 to 14 of the accompanying drawings. The truck bed extension apparatus 10 includes an auxiliary tailgate 40, a pair of side panels 46, and a hinge assembly 20 for use with a truck bed 2, also referred to as a pickup box, having a primary tailgate 3.

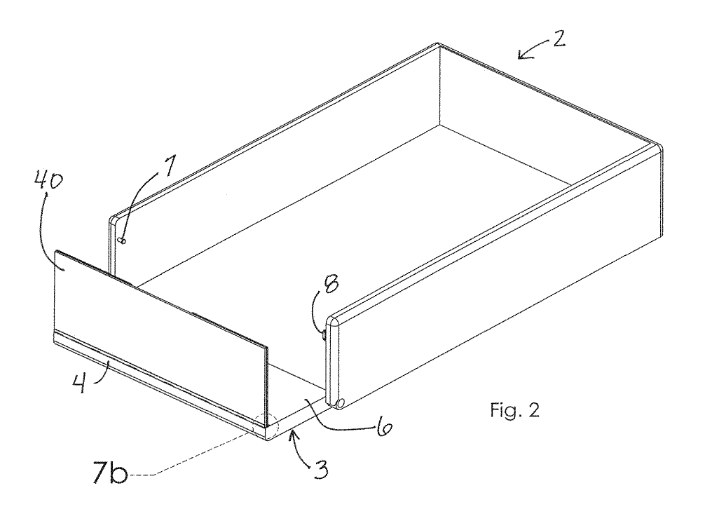

The primary tailgate 3 of a pickup truck is pivotally movable between a closed configuration (FIG. 5) that blocks access to the interior of the pickup box 2 via its open rear end and an open configuration (FIGS. 2 to 4) that allows access to the interior, a.k.a. truck bed, via its open rear end. The primary tailgate 3 has a free edge 4 and may include a handle 5 configured to release the primary tailgate 3 to move between closed and open configurations. A conventional pickup box 2 may include fasteners adjacent the open rear end that are useful in fastening a portion of the present invention to the pickup box 2 as will be described later.

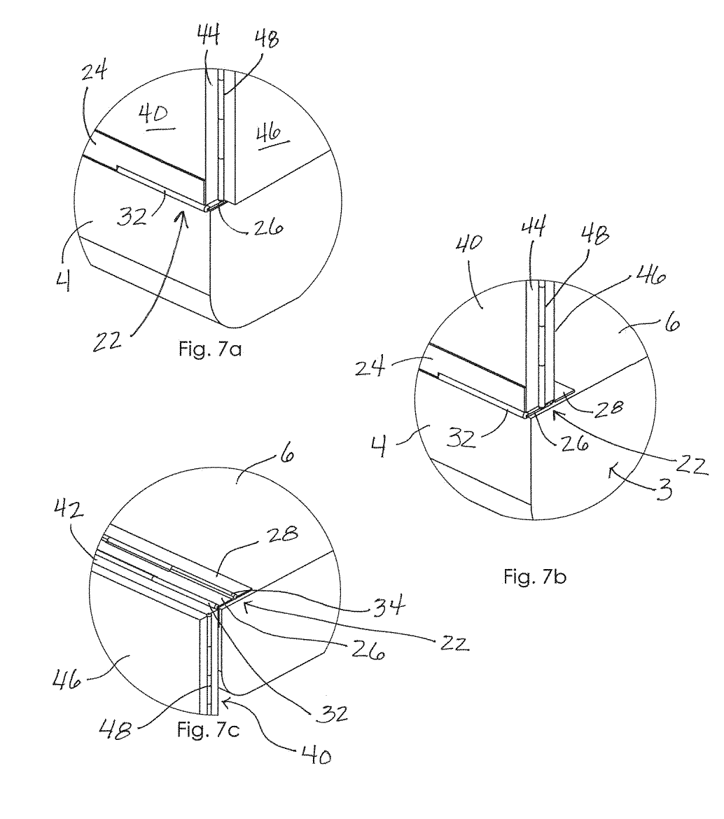

The hinge assembly 20 of the truck bed extension apparatus 10 is coupled to the primary tailgate 3 of a truck and provides the means for mounting the additional components to the primary tailgate 3. More particularly, the hinge assembly 20 includes a hinge plate 22 having a front portion 24 that is, at deployed and released configuration, situated adjacent the free edge 4 of the primary tailgate 3 of a pickup truck. In fact, the front portion 24 may be coupled to the auxiliary tailgate 40, such as with bolts (not shown). Preferably, the hinge assembly 20 includes a double hinge member 30 having a first hinge 32 and a second hinge 34 rearwardly displaced from and parallel to the first hinge 32 (FIG. 7c). The hinge plate 22 includes a first plate section 26 extending between the first hinge 32 and the second hinge 34 and a second plate section 28 extending rearwardly (away from) the second hinge 34 (FIG. 7b). The second plate section 28 may be fixedly attached to the inner surface 6 of the primary tailgate 3, such as with bolts (not shown), while the first plate section 26 movable relative to the inner surface 6 of the primary tailgate 3 as will be described in more detail below.

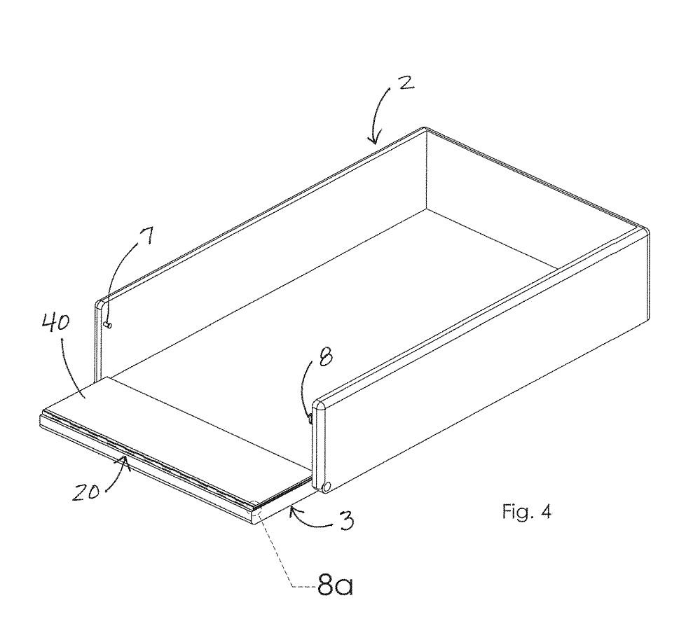

The auxiliary tailgate 40 may have a generally rectangular configuration having a lower edge 42 (or “base edge”) and opposed side edges 44. The auxiliary tailgate 40 may have dimensions that are substantially similar to the dimensions of the primary tailgate 3. The lower edge 42 of the auxiliary tailgate 40 may be operably coupled to the hinge assembly 20 and pivotally movable between a stowed configuration that is generally co-planar with and adjacent to the inner surface 6 of the primary tailgate 3 (FIG. 4) and a deployed configuration generally perpendicular to and extending upwardly from the inner surface 6 of the primary tailgate 3 (FIG. 2). Clearly, when the primary tailgate 3 is at its open configuration and the auxiliary tailgate 40 is at the deployed configuration, access to the interior of the pickup box 2 is blocked.

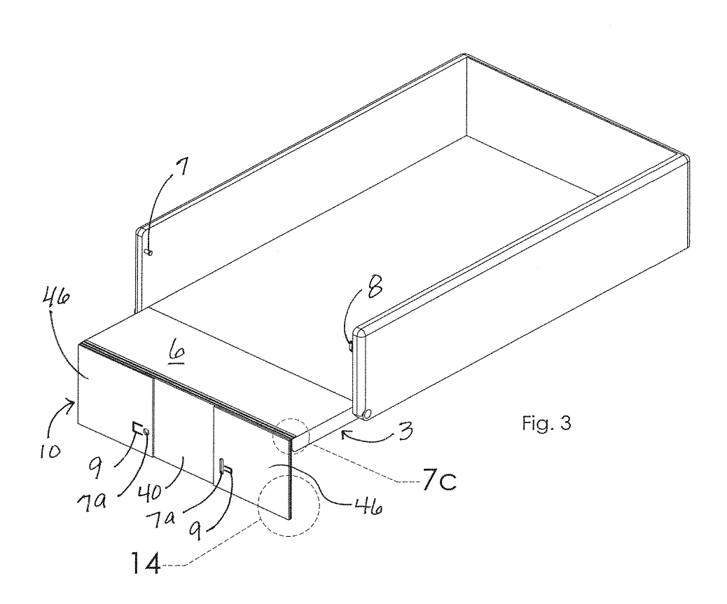

The auxiliary tailgate 40 is pivotally movable by operation of the hinge assembly 20. More particularly, the auxiliary tailgate 40 is pivotally movable to a released configuration generally perpendicular to and extending downwardly from the front portion 24 of the hinge plate 22 and free edge 4 of the primary tailgate 3 (FIG. 3). When the primary tailgate 3 is at its open configuration and the auxiliary tailgate 40 is at the released configuration, access to the interior of the pickup box 2 is not blocked. Movement of the auxiliary tailgate 40 between the deployed configuration and released configuration is by operation (pivotal rotation) of the first hinge 32.

It will be understood that the double hinge assembly 20 enables about 270 degrees of rotation upon operation of the first hinge 32 and second hinge 34, respectively. Specifically, the auxiliary tailgate 40 is rotated about 90 degrees from the stowed configuration (FIG. 4) to the deployed configuration (FIG. 2). Similarly, the auxiliary tailgate 40 is rotated about 180 degrees from the deployed configuration (FIG. 2) to the released configuration (FIG. 3).

In an embodiment, selective operation of the first hinge 32, second hinge 34, and hinge plate 22 are required to move the auxiliary tailgate 40 from the stowed configuration to the deployed configuration to the released configuration and back again. As shown in FIG. 7b (illustrating the deployed configuration) and FIG. 7c (illustrating the released configuration), the hinge plate 22 of the double hinge member 30 lies flat atop the inner surface 6 of the primary tailgate 3. In addition, a front portion 24 of the hinge plate 22 and first hinge 32 are adjacent the free edge 4 of the primary tailgate 3. Movement of the auxiliary tailgate 40 between the deployed and released configurations is by a 180 degree rotational movement of the first hinge 32, the lower edge 42 of the auxiliary tailgate 40 being coupled to the first hinge 32.

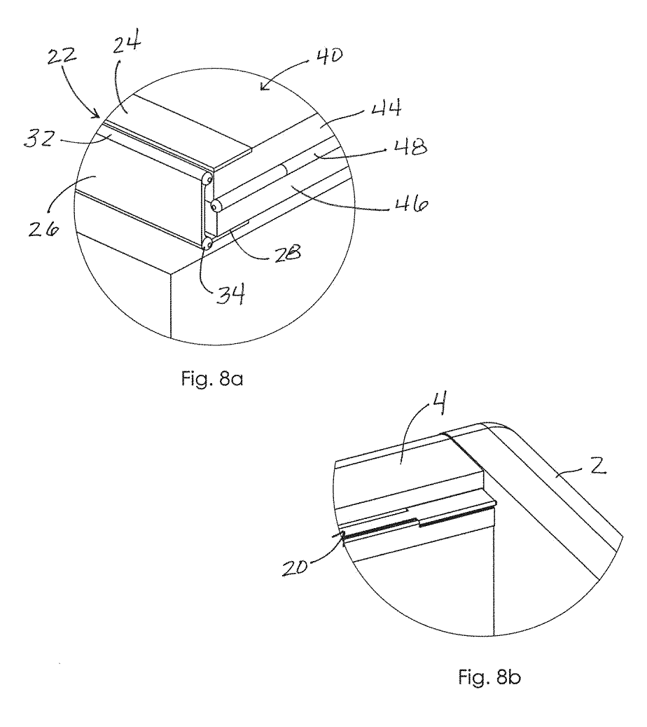

Movement of the auxiliary tailgate 40 to the stowed configuration (FIG. 4), however, involves rotation of the second hinge 34. More particularly, the first hinge plate 22 is displaced from the inner surface 6 of the primary tailgate 3 and is rotated by the second hinge 34 until it becomes situated substantially vertical and perpendicular relative to the second plate section 28 (FIG. 8a). At this configuration (stowed), the first hinge 32 and second hinge 34, while still displaced, are situated in a common vertical plane (FIG. 8a). As a result, the auxiliary tailgate 40 is essentially positioned atop or adjacent the inner surface 6 of the primary tailgate 3. At the stowed configuration, the primary tailgate 3 may be pivotally moved to the closed configuration in a conventional manner without any interference by the auxiliary tailgate 40 (FIG. 8b).

In another aspect, the truck bed extension apparatus 10 includes a pair of side panels 46 pivotally coupled to opposed side edges 44 of the auxiliary tailgate 40, respectively. Each side panel 46 may be pivotally attached with hinges 48 and is selectively movable between a between a retracted configuration that is generally co-planar with or bearing against an inside surface of the auxiliary tailgate 40 (FIG. 3) and an extended configuration generally perpendicular to the inside surface of the auxiliary tailgate 40 (FIG. 1). In other words, the side panels 46 may be selectively rotated to closed positions, such as when the auxiliary tailgate 40 is being moved to the stowed configuration. However, the side panels 46, when moved to the extended configurations, provide extensions of the pickup box side walls. To be clear, the “extended truck bed” is extended and enclosed when the primary tailgate 3 is at the opened configuration, the auxiliary tailgate 40 is at the deployed configuration, and the pair of side panels 46 is at the extended configuration (FIG. 1).

Modern pickup trucks include one of two types of fasteners adjacent the rear open end of the truck bed or pickup box. In one instance, a post 7 may extend inwardly from a side panel of the pickup box 2 (FIG. 13a). Accordingly, each side panel 46 may define an aperture 7a complementary to the post 7 for selective attachment thereto. In another instance, a D-ring fastener 8 may extend inwardly from a respective side panel (FIG. 13b). In this construction, each side panel 46 may include a slider 9 configured to selectively engage with the D-ring fastener 8 (FIG. 13b). In either configuration, the side panels 46 are releasably but securely coupled to the side panels of the truck bed itself.

In use, the truck bed extension apparatus 10 may be mounted to the inner surface 6 of a conventional truck primary tailgate 3, such as by bolting or screwing a portion of the hinge plate 22 of the hinge assembly 20 to the tailgate. With the auxiliary tailgate 40 at the stowed configuration, the primary tailgate 3 may be operated in a customary manner. However, if a user desires to extend the truck bed, the primary tailgate 3 is released to the open configuration and the auxiliary tailgate 40 is rotated to the upstanding/deployed configuration (FIG. 2). To enclose the now extended truck bed, the pair of side panels 46 may be pivotally moved to respective extended configurations and locked in as described above (FIG. 1).

As aspect of at least one of the inventions disclosed herein includes the realization that generic hinge assemblies can suffer from sagging of the auxiliary tailgate 40, relative to the primary tailgate 3 when in the stowed and closed position. For example, with reference to FIG. 15, when the primary tailgate 3 is in a closed position, such that the inner surface 6 of the primary tailgate 3 is generally vertical, the auxiliary tailgate 40 can sag downwardly.

More specifically, with continued reference to FIG. 15, with the second plate section 28 of the hinge assembly 20 mounted to the inner surface 6 of the primary tailgate 3, the full weight of the auxiliary tailgate 40 and the side panels 46 are supported by the remaining portions of the hinge assembly 20. Namely, the full weight of the auxiliary tailgate 40 and the side panels 46 are supported by the front portion 24 of the hinge assembly 20, the first plate section 26, and the first and second hinges 32, 34. The weight W of the auxiliary tailgate 40 and the side panels 46 pulls downwardly on the hinge assembly 20. The weight W is transferred to the hinge assembly through the connection of the auxiliary tailgate 40 to the front portion 24 of the hinge assembly 20.

Illustrated in exaggerated scale in FIG. 15, the weight W pulls downwardly on the hinge assembly 20, causing the auxiliary tailgate 40 and side panels 46 to sag downwardly by a sag amount identified generally by the reference in numeral 50. The sag amount 50 represents a distance by which the auxiliary tailgate 40 is displaced downwardly from a position that would result if the first plate section 26 were normal to the second plate section 28. The sag amount 50 can cause the auxiliary tailgate 40 and side panels 46 to sag below a lower edge of the primary tailgate 3 by an amount 52. Sagging as such, auxiliary tailgate 40 and side panels 46 can interfere with the closing of the primary tailgate 3, by sagging into an area between the lower edge of the primary tailgate 3 and rear edge of a pickup bed. In order to avoid such interference, the auxiliary tailgate 40 and side panels 46 can be made shorter such that when sagging, in the orientation illustrated in FIG. 15, they do not interfere with the closing of the primary tailgate 3.

Shortening the auxiliary tailgate 40 and/or the side panels 46 can be undesirable. For example, such shortening of the auxiliary tailgate 40 and the side panels 46 will reduce the enclosed volume created by the auxiliary tailgate 40 and the side panels 46 when in the deployed position, with the primary tailgate 3 in an open position. This can also alter the overall aerodynamics of the vehicle to which the extension apparatus 10 is installed.

An aspect of at least one of the inventions disclosed herein includes the realization that modifying the hinge assembly 20 so as to limit the range of movement of the first plate section 26 relative to the second plate section 28 about the first hinge 32 can prevent the sagging illustrated in FIG. 15.

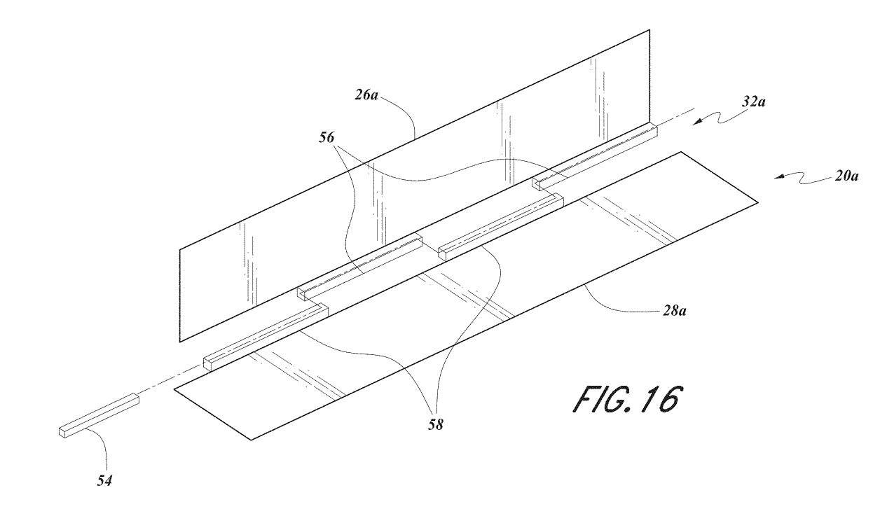

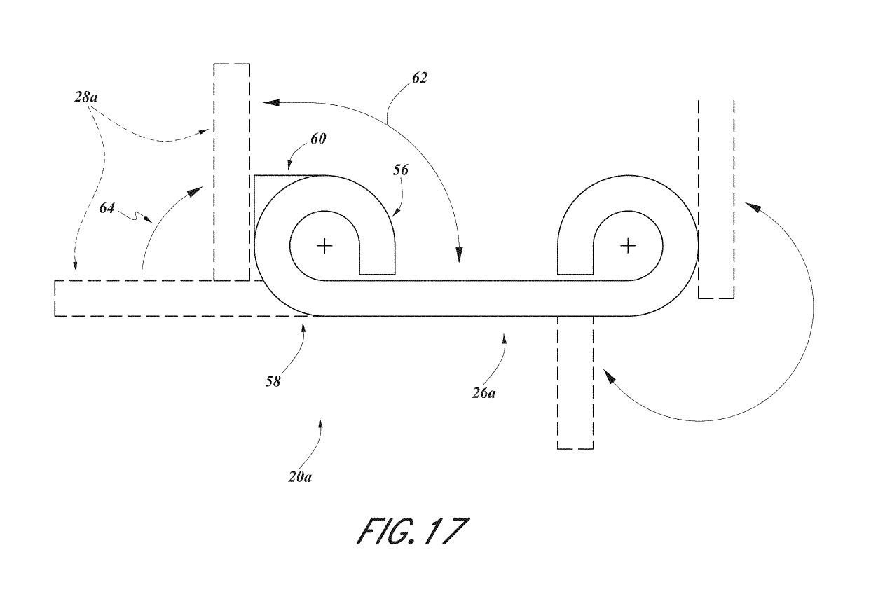

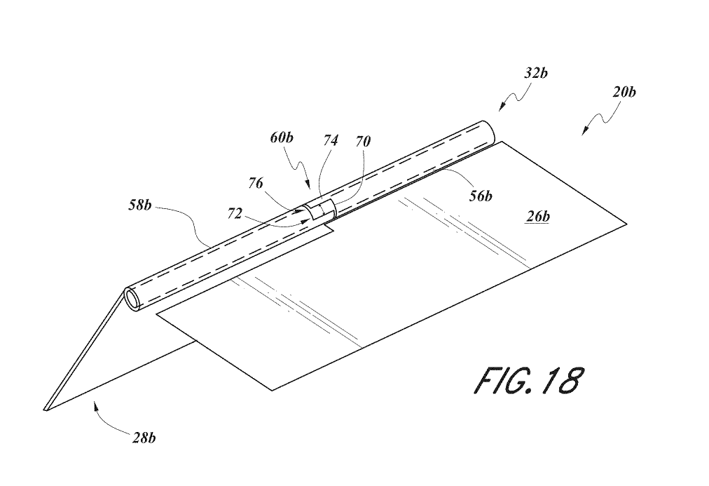

FIGS. 16 and 17 illustrate embodiments of a modification of the hinge assembly 20, identified generally by the reference numeral 20A. Parts, components, features and advantages of the hinge assembly 20A that are the same or similar to the corresponding parts, components, features or advantages of the hinge assembly 20 are referred to using the same reference numerals except that a letter “A” is added thereto.

With continued reference to FIG. 16, a portion of the hinge assembly 20A is illustrated therein, including first plate section 26A, second hinge plate section 28A and first hinge 32A.

The first hinge 32A includes a hinge pin 54 and a plurality of knuckles. For example, a plurality of first knuckles 56 can be attached to the first plate section 26A and a plurality of second knuckles 58 can be attached to the second plate section 28A. The knuckles 56 are spaced apart from each other along an inner edge of the first plate section 26A. Similarly, the second knuckles 58 are also spaced apart from one another along an inner edge of the second plate section 28A.

The knuckles 56, 58 are arranged such that they interleave with one another so as to form a continuous cylindrical passage into which the pin 54 is inserted. With the knuckles 56, 58 moved into alignment such that they are interleaved with one another, and with the pin 54 inserted through the cylindrical passage formed by the aligned knuckles 56, 58, the hinge 32A connects the first and second plate sections 26A, 28A such that they can pivot relative to one another about the hinge pin 54. This type of construction and functionality of a hinge is well known in the art.

In some embodiments, the hinge assembly 20A can be configured to limit movement of the first and second plate sections 26A, 28A such that they cannot be moved pivoted to an angle less than 90 degrees, in at least one orientation. For example, the knuckles 56, 58 can be arranged and spaced from each other such that they interfere with the movements of the plate sections 26A, 28A. Optionally, in some embodiments, the hinge assembly 20A can include physical stops in one or more locations configured to limit the movement of the first and second plate sections 26A, 26B.

With reference to FIG. 17, the hinge assembly 20A can include one or more physical stops 60 configured to limit movement of the hinge plate 28A relative to the hinge plate section 26A. For example, the physical stop 60 can limit the movement of the first and second hinge plate sections 26A, 28A to an angle 62 of approximately 90 degrees, for example, an angle 62 in the range of about 86 degrees to 94 degrees. The physical stop 60 can be a separate piece mounted to either or both of the knuckles 56, 58 or can be formed integrally or monolithically with one or more of the knuckles 56, 58.

In the illustrated embodiment, the physical stop 60 is attached to knuckle 56. When the second hinge plate section 28A is moved in the direction of the closing direction 64, an inner surface of the second hinge plate section 28A contacts the physical stop 60, and thereby limits the pivotal movement of the second hinge plate section 28 relative to the first hinge plate section 26A to the angle 62. The positioning of the physical stop 60 can be chosen so as to provide the desired limitation on the pivoting movement described above. Other angles can also be chosen. For example, the physical stop 60 can be placed so as to limit the angle 62 to an angle so it would be greater than 90 degrees, so as to accommodate potential bending of portions of the hinge assembly 20A and thus prevent undesirable sagging that could result from such bending.

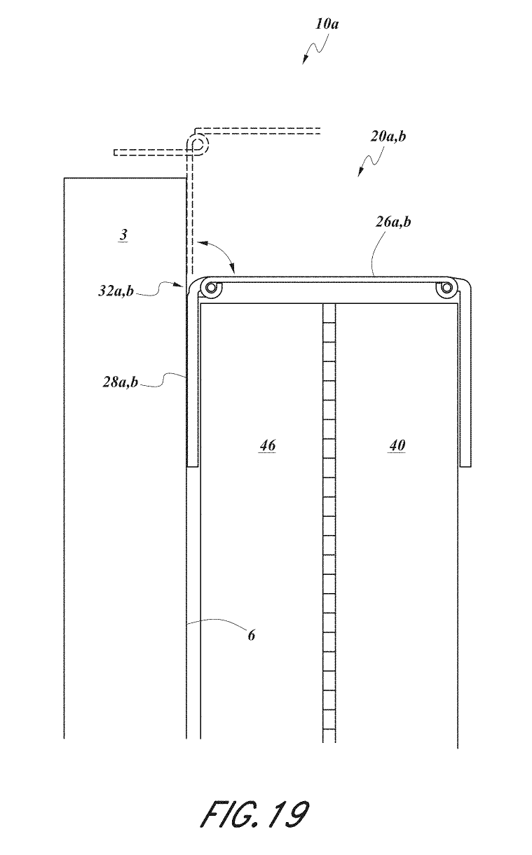

FIG. 18 illustrates a further modification of the hinge assembly 20 identified generally by the reference numeral 20B. Parts, components, features and advantages of the hinge assembly 20B that are similar or the same as hinge assemblies 20 or 20A are identified with the same reference numeral, except that a letter “B” has been added thereto.

With reference to FIG. 18, the hinge assembly 20B is illustrated with only small portions of first and second hinge plate sections 26B, 28B and each having a single knuckle 56B, 58B. However, it is to be understood that the hinge plate sections 26B, 28B could have any length and include any number of knuckles 56B, 58B.

The hinge assembly 20B includes a physical stop 60B incorporated into juxtaposed ends of the knuckles 56B, 58B.

For example, the knuckle 56B, being directly attached or formed as an integrated portion of the hinge plate section 26B, can include an end surface 70. The end surface can include a projection or recess configured to cooperate with end surface 72 of knuckle 58B.

For example, the end surface 70 can include projection 74 having a predetermined width. The width of the projection 74 can extend around the cylindrical passage defined by the knuckle 56B a predetermined amount. Similarly, end surface 72 of the knuckle 58B can include a recess 76 configured to be interleaved with projection 74. Additionally, the recess 76 can extend around the cylindrical passage defined by the knuckle 58B a predetermined amount. The sizes of the projections 74 and the recess 76 can be configured to provide a limited range of movement of the hinge assembly B and in particular, range of pivoting movement of the hinge plate sections 26B, 28B, relative to one another. When moved in a pivoting motion, the projection and recess interfere with each other, and thereby limit the range of motion of the hinge plate sections 26B, 28B. In some embodiments, the physical stop assembly 60B can be configured to provide the same limits on range of motion described above with reference to FIG. 17 and the hinge assembly 20A.

With reference to FIG. 19, the extension apparatus 10A can include any of the above-described embodiments of the hinge assembly 20A, 20B. As such, when the auxiliary tailgate 40 and side panels 46 are in the stowed position, with the primary tailgate 3 in a closed position, in which its inner surface 6 is generally vertical, the hinge 32A or 32B limits the movement of the first hinge plate section 26A, B to a position roughly normal to the second hinge plate section 28A, B. As such, the sagging described above with regards to FIG. 15 is better prevented. Additionally, auxiliary tailgate 40 can be moved to a deployed position in which the first hinge plate section 26A, B is pivoted upwardly (as viewed in FIG. 19) with the auxiliary tailgate extending generally normal to the inner surface 6 of the primary tailgate 3. Additionally, the auxiliary tailgate 40 can then be pivoted to a release position approximately 180 degrees from the deployed position, as described above with reference to FIGS. 7-8.

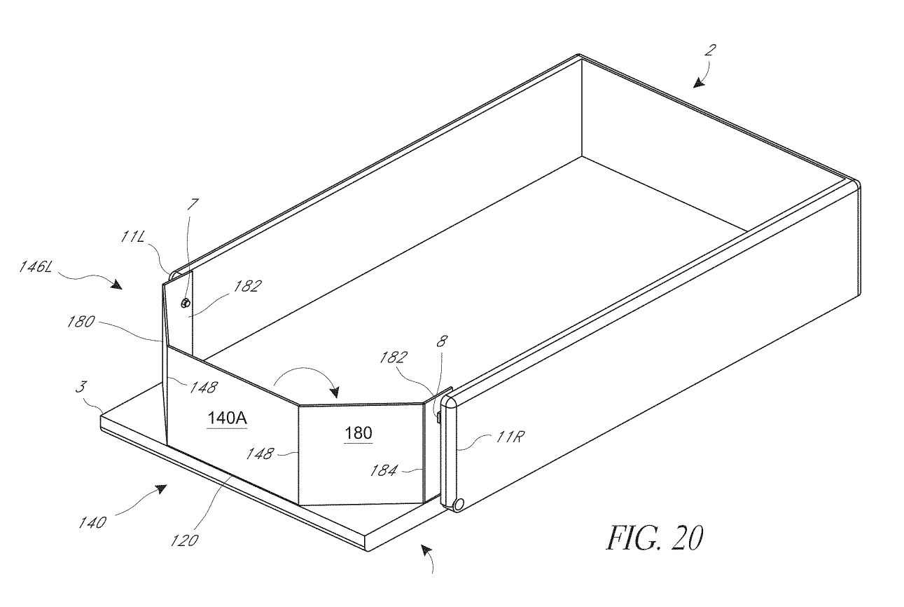

FIGS. 20-22 illustrate another embodiment of the auxiliary tailgate 40, identified generally by the reference numeral 140. Parts, components, and features of the auxiliary tailgate 140 that are similar or the same as corresponding parts, features, and components of the auxiliary tailgate 40 are identified with the same reference numeral except that “100” has been added to value thereof.

With reference to FIG. 20, a truck bed 2 of a pickup truck can include left and right taillights 11L, 11R, as is typical for on-highway vehicles. An aspect of at least one of the inventions disclosed herein includes the realization that bed extenders for pickup trucks can include various features for improving visibility of taillights thereof, such as the taillights 11L, 11R.

With regard to the embodiment of FIGS. 20-22, the auxiliary tailgate can include faceted or beveled corners, providing for a wider viewing angle with regard to the light emitted by the taillights 11L, 11R. For example, the auxiliary tailgate 140 can include faceted side panel assemblies 146L, 146R.

With continued reference to FIG. 20, the auxiliary tailgate assembly 140 can include a central panel 140A that is connected to the primary tailgate 3 of the pickup bed 2 with a hinge assembly 120. The central panel 140A having a deployed configuration in which it is generally perpendicular to and extending upwardly from the primary tailgate 3. The hinge assembly 120 can allow for the pivotal movement of the central panel 140A in accordance with the disclosure set forth above with regard to the hinge assemblies 20 and 20A.

The left and the right side panel assemblies 146L, 146R can be pivotally attached to the central panel 140A with hinges 148. In some embodiments, the side panel assemblies 146L, 146R can each be formed with a plurality of panels. The left and the right side panel assemblies 146L, 146R can have an extended configuration in which they are pivoted outwardly from the central panel 140A to be generally perpendicular to and extending upwardly from the primary tailgate 3, as illustrated in FIG. 20.

With reference to FIG. 20, the side panel assembly 146L can include a first panel 180 and a second panel 182. The first and second panels can be connected to each other by hinge 184, which can have a construction the same or similar to that as hinge 148.

The second panel 182 include an aperture 7A (not shown) similar to that of side panels 46, for attachment to post 7 or D-ring fastener 8. The above description of the side panel 146R also applies to the side panel assembly 146L.

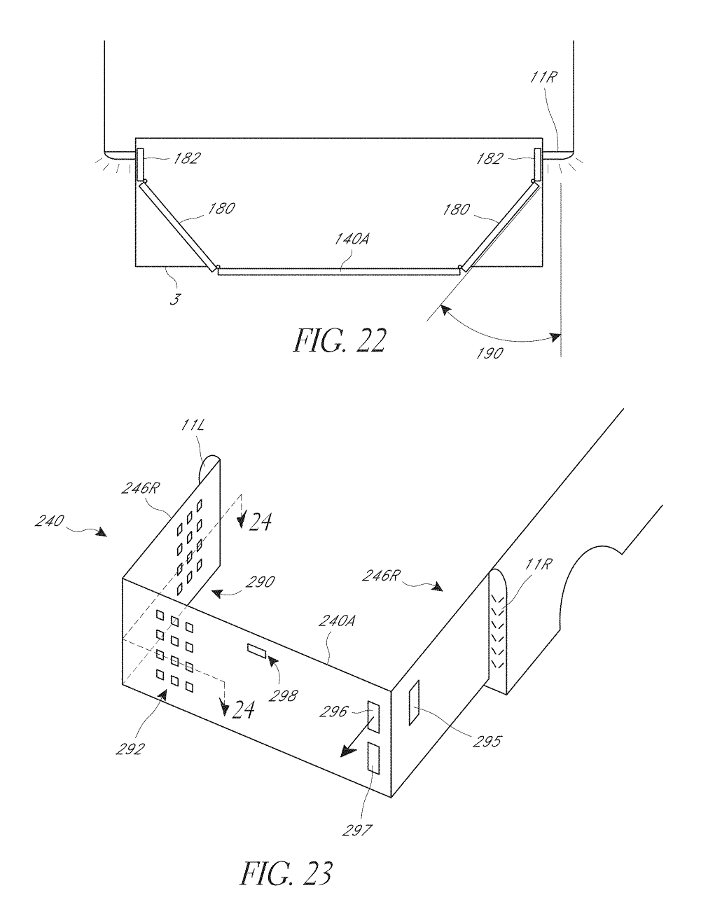

The lengths of the first and second panels 180, 182 and the central panel 184A can be chosen so as to provide the desired viewing angle of the taillight 11R. For example, with reference to FIG. 22, the lengths of the central panel 140A, panel 180, and panel 182 can be chosen to define a viewing angle 190 of the taillight 11R. In other words, the lengths of the panels 140A, 180, 182 can be chosen such that the viewing angle 190 is at a desired magnitude. Generally, the viewing angle 190 will be greater when the length of the central panel 140A is shorter; the central panel 140A being centered on the tailgate 3. The length of the panel 180 can similarly be adjusted so as to extend between the end of panel 140A and the end of panel 182. In some embodiments the viewing angle 190 is at least about 45°. The various panel members can be made at different lengths to achieve other viewing angles 190.

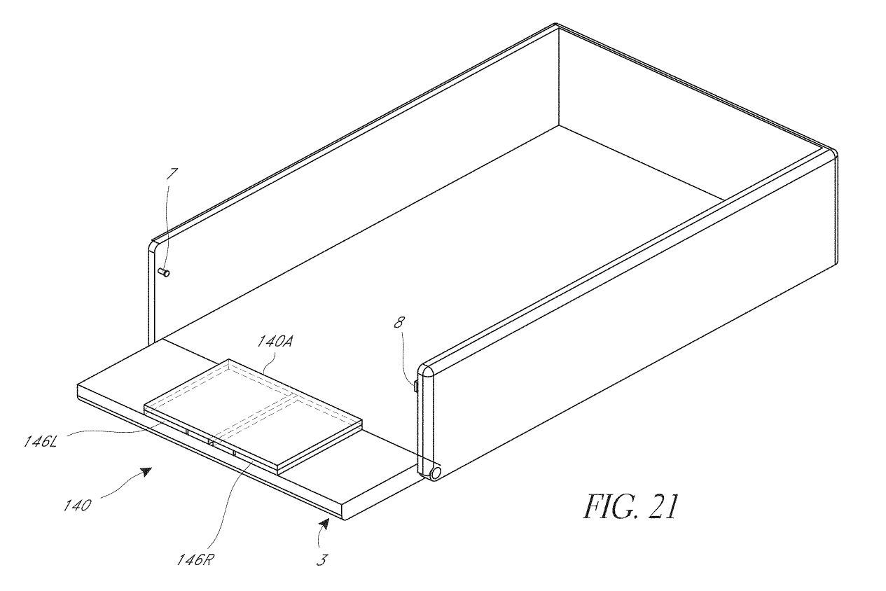

FIG. 21 illustrates the auxiliary tailgate 140 in a folded position on top of the primary tailgate 3 and with the hinge 120 removed. As shown in FIG. 21, the left and right side panel assemblies 146L, 146R are folded beneath the central panel 140A when in folded position, folded flat against the primary tailgate 3.

FIG. 23 illustrates a modification of the auxiliary tailgate 40, identified generally by the reference numeral 240. Parts, features, and components of the auxiliary tailgate 240 which are similar or the same as corresponding parts, components, and features of the auxiliary tailgate 40 or 140 are identified with the same reference numeral, except that an “200” has been added thereto.

In some embodiments, the auxiliary tailgate 240 can include a plurality of apertures configured to enhance visibility of taillights 11L, 11R. For example, as illustrated on the left side of the auxiliary tailgate 240, the panel 246 can include a first plurality of apertures 290 and the central panel 240A can include a second plurality of apertures 292. The pluralities of apertures 290, 292 can be aligned along a sightline extending from the taillight 11L, and through the panels 246, 240A.

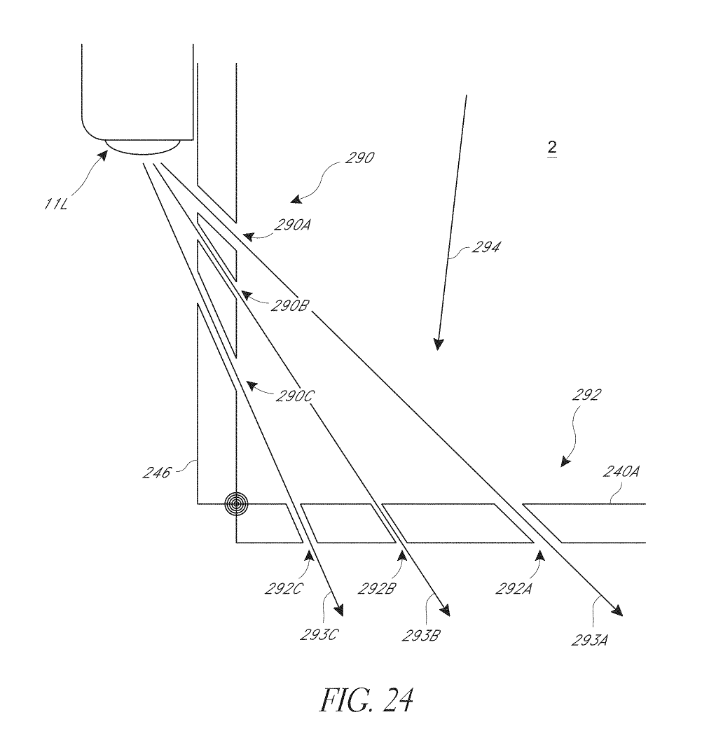

With reference to FIG. 24, the pluralities of apertures 290, 292 can be grouped into a plurality of paired columns. For example, the plurality of apertures 290 can include columns of apertures identified as 290A, 290B and 290C. Similarly, the plurality of aperture 292 can include a column of apertures of 292A, 292B, and 292C. The columns of the respective pluralities of apertures 290, 292 can be paired to cooperate for accommodating sightlines from the rear of a vehicle having the bed 2 to an area behind the vehicle and the tailgate extender. For example, the columns 290A, 292A can be aligned so as to provide sightline 293A. Similarly, column of apertures 290B can be aligned with the column of apertures 292B, to provide sightline 293B. Additionally, column of apertures 290C can be aligned with column of apertures 292C to define sightline 293C.

Further, as illustrated in FIG. 24, the apertures forming the pluralities of apertures 290, 292 can be cut through the thickness of the material forming the panel 246 and central panel 240A along the direction of the sightlines 293A, 293B, 293C. Such a configuration of the apertures can create a louvered effect thereby blocking a line of sight through the apertures 290, 292 along directions that are perpendicular to the panels 240A, 246. For example, the sightline identified by arrow 294 in FIG. 22 might be a sightline extending from a rear view mirror of a vehicle having the associated bed 2. As such, along the sightline 294, the apertures 292, 290 would not appear to be through holes, in other words, the sightline 294 would not extend through the central panel 240A or the panel 246.

Although described only with regard to the taillight 11L on the left side of the auxiliary tailgate assembly 240, a similar or the same arrangement of apertures 290, 292 could be provided on the right side of the auxiliary tailgate 240 and side panel 246R.

With continued reference to FIG. 23, in another embodiment, the auxiliary tailgate assembly 240 can include one or more prisms configured to guide light from the taillight 11R to a rear facing surface of the central panel 248. For example, as shown in FIG. 23, the right side side panel 246R can include a first prism 295 and a second prism 296. The first prism 295 can be configured to capture light from the taillight 11R, and redirect the light received from the taillight 11R to the prism 296. The prism 296 can be configured to received light from the prism 295, and disperse light rearwardly from the rear-facing surface of the central panel 204A. A similar arrangement of the prisms 295, 296 can also be provided on the left side of the auxiliary tailgate assembly 240.

In some embodiments, the auxiliary tailgate 240 can also include one or more auxiliary taillights, 297. For example, the auxiliary taillight 297 can include one plurality of LED lights wired to the taillight 11R and thus be activated in synchronicity with the taillight 11R. Additionally, another auxiliary taillight 297 can be provided on the left side of the auxiliary tailgate assembly 240.

In some embodiments, the auxiliary tailgate assembly 240 can also include a backup camera 298 mounted to the central panel number 240. In some embodiments, the backup camera 298 can be embedded into the central panel 240A so as to be flush with the outer surface of the central panel 240A. The auxiliary taillight 297 can also be mounted as such.

Further, the wiring for either or both the backup camera 298 and the auxiliary taillight 297 can be embedded within the material forming the central panel 240A and/or the side panel 246R. For example, the panels 240A and 246 can be made of a plastic material. Wiring can be disposed along a groove cut in the plastic material and covered with a film material. In one implementation, the wiring can be disposed through one of the panels 246L, 246R and connect with the corresponding taillight 11R or 11L. In one implementation, the wiring for the auxiliary taillight 297 can include a plug assembly. The taillight 11R or 11L can include a corresponding plug assembly wired therewith for connection with wiring of the auxiliary taillight 297. Other configurations can also be used.

It is understood that while certain forms of the inventions have been illustrated and described, they are not limited thereto except insofar as such limitations are included in the following claims and allowable functional equivalents thereof.

What is claimed is:

1. A truck bed extension apparatus for use in extending a usable area of a truck having a pickup box that defines an open end and that includes a primary tailgate pivotally movable between a closed configuration impeding the open end and an open configuration not impeding the open end, said bed extension apparatus comprising:
an auxiliary tailgate coupled with the primary tailgate, a central panel of the auxiliary tailgate supported by a hinge assembly for pivotal movement relative to the primary tailgate, the central panel having a deployed configuration;
left and right side panel assemblies pivotally coupled with the central panel at opposite ends thereof, the left and right side panel assemblies having an extended configuration;
wherein the pickup box is extended and enclosed when the primary tailgate is at the open configuration, said central panel is at said deployed configuration, and said left and right side panel assemblies are at the extended configuration; and
wherein a right rear taillight of the truck is viewable past a beveled corner of the auxiliary tailgate when the primary tailgate is at the open configuration, said central panel is at said deployed configuration, and said left and right side panel assemblies are at the extended configuration, the beveled corner formed by the right side panel assembly.

2. The truck bed extension apparatus as in claim 1, wherein the beveled corner of the auxiliary tailgate defines a viewing angle of the right rear taillight of at least about 45 degrees.

3. The truck bed extension apparatus as in claim 1, wherein a left rear taillight of the truck is viewable past a second beveled corner of the auxiliary tailgate when the primary tailgate is at the open configuration, said central panel is at said deployed configuration, and said left and right side panel assemblies are at the extended configuration, the second beveled corner formed by the left side panel assembly and defining a viewing angle of the left rear taillight of at least about 45 degrees.

4. The truck bed extension apparatus as in claim 1, wherein the right side panel assembly comprises a first panel and a second panel, the second panel pivotally coupled with the first panel, the first panel forming the beveled corner of the auxiliary tailgate and the second panel coupled with a side of the pickup box.

5. The truck bed extension apparatus as in claim 4, wherein the second panel includes one of an aperture for coupling with one of a post and a D-ring fastener extending from the side of the pickup box.

6. The truck bed extension apparatus as in claim 1, wherein the hinge assembly includes a first hinge plate configured to be coupled to the primary tailgate, a second hinge plate pivotally connected to the first hinge plate with a first hinge mechanism and a third hinge plate connected to the second hinge plate with a second hinge mechanism, the central panel coupled with the third hinge plate.

7. A truck bed extension apparatus for use in extending a usable area of a truck having a pickup box that defines an open end and that includes a primary tailgate pivotally movable between a closed configuration impeding the open end and an open configuration not impeding the open end, said bed extension apparatus comprising:
an auxiliary tailgate coupled with the primary tailgate, a central panel of the auxiliary tailgate supported by a hinge assembly for pivotal movement relative to the primary tailgate, the central panel having a deployed configuration;
left and right side panel assemblies pivotally coupled with the central panel at opposite ends thereof, the left and right side panel assemblies having an extended configuration;
wherein the pickup box is extended and enclosed when the primary tailgate is at the open configuration, said central panel is at said deployed configuration, and said left and right side panel assemblies are at the extended configuration; and
wherein light from a right rear taillight of the truck is viewable through apertures extending through the central panel and the right side panel assembly.

8. The truck bed extension apparatus as in claim 7, wherein the apertures are aligned along one or more sightlines extending from the right rear taillight.

9. The truck bed extension apparatus as in claim 7, wherein the apertures through the central panel are louvered to block a line of sight through the apertures along directions perpendicular to the central panel.

10. The truck bed extension apparatus as in claim 7, wherein the apertures are aligned in one or more paired columns.

11. The truck bed extension apparatus as in claim 7, wherein the apertures include one or more prisms therein for redirecting the light through an interior of the auxiliary tailgate and outwardly through the central panel.

12. A truck bed extension apparatus for use in extending a usable area of a truck having a pickup box that defines an open end and that includes a primary tailgate pivotally movable between a closed configuration impeding the open end and an open configuration not impeding the open end, said bed extension apparatus comprising:
an auxiliary tailgate coupled with the primary tailgate, a central panel of the auxiliary tailgate supported by a hinge assembly for pivotal movement relative to the primary tailgate, the central panel having a deployed configuration;
left and right side panel assemblies pivotally coupled with the central panel at opposite ends thereof, the left and right side panel assemblies having an extended configuration;
wherein the pickup box is extended and enclosed when the primary tailgate is at the open configuration, said central panel is at said deployed configuration, and said left and right side panel assemblies are at the extended configuration; and
wherein the auxiliary tailgate includes an integrated auxiliary taillight on a rear facing wall thereof.

13. The truck bed extension apparatus as in claim 12, wherein the auxiliary tailgate includes left and right rear auxiliary taillights.

14. The truck bed extension apparatus as in claim 12, wherein the integrated auxiliary taillight is mounted flush with an outer surfaces of the rear facing wall.

15. The truck bed extension apparatus as in claim 12, wherein the integrated auxiliary taillight comprises one or more LEDs.

16. The truck bed extension apparatus as in claim 12, wherein wiring for the integrated auxiliary taillight is embedded within one of the central panel and the left and right side panel assemblies.

17. The truck bed extension apparatus as in claim 16, wherein the wiring for the integrated auxiliary taillight is connectable with one of a left rear taillight and a right rear taillight of the truck, the wiring embedded within the corresponding left or right side panel assembly.

18. The truck bed extension apparatus as in claim 16, wherein the wiring is embedded within a first panel and a second panel of the one of the left and right side panel assemblies.

19. The truck bed extension apparatus as in claim 12, wherein the auxiliary tailgate includes an auxiliary backup camera mounted in the rear-facing wall.

20. The truck bed extension apparatus as in claim 19, wherein the auxiliary backup camera is mounted on an outer surface of the auxiliary tailgate to avoid damage when the auxiliary tailgate is folded into a stowed configuration.
